(19) United States
(12) Patent Application Publication
(10) Pub. No.: US 2020/0062926 A1
(43) Pub. Date: Feb. 27, 2020

(54) METAL-COATED PARTICLES AND RESIN COMPOSITION

(71) Applicant: NAMICS CORPORATION, Niigata-shi, Niigata (JP)

(72) Inventor: Tomoyuki TAKAHASHI, Niigata-shi, Niigata (JP)

(73) Assignee: NAMICS CORPORATION, Niigata-shi, Niigata (JP)

(21) Appl. No.: 16/346,673

(22) PCT Filed: Nov. 2, 2017
(86) PCT No.: PCT/JP2017/039670

§ 371 Date: May 1, 2019

(30) Foreign Application Priority Data
Nov. 14, 2016 (JP) 2016-221487

(51) Int. Cl. C08K 9/02; C01G 23/04; C08L 101/00; H01B 1/20

(52) U.S. Cl. CPC C08K 9/02; C01G 23/04; C08L 101/00; H01B 1/20; C01P 2004/03; C08K 2201/004; C01P 2004/60; C01P 2006/12; C08L 2203/20; C08K 2201/001; C08K 2201/003; C01P 2004/54

(57) ABSTRACT

Obtained are metal-coated particles able to be used in a resin composition capable of forming the wiring of an electrical circuit and/or electronic circuit having a low possibility of disconnection. The metal-coated particles have a metal coating layer on the surface of titanium oxide, wherein the titanium oxide has a columnar shape having a particle length and a particle diameter and the particle length of the titanium oxide is longer than the particle diameter, and the metal-coated particles have a columnar shape having a particle length and a particle diameter and the particle length of the metal-coated particles is longer than the particle diameter.

### TECHNICAL FIELD

The present invention relates to metal-coated particles able to be used as conductive particles of conductive paste used in electrical components and electronic components, and to a resin composition containing the metal-coated particles.

### BACKGROUND ART

Patent Document 1 describes the use of flake-like silver particles, having a sodium content of 0.0015% by weight or less and value of the ratio (D₉₀-D₁₀)/D₅₀ in excess of 1.5, as silver particles for conductive paste used in electronic components.

In addition, Patent Document 2 describes a method for producing spherical silver powder that includes reducing and depositing silver particles by mixing a reducing agent-containing solution, containing an aldehyde as a reducing agent, in an aqueous reaction system containing silver ions while causing the occurrence of cavitation.

On the other hand, conductive elastomers, obtained by adding metal powder, carbon fibers, carbon powder or graphite powder and the like to a matrix such as polyurethane or silicone rubber, are used as materials of electronic components such as connectors, switches or sensors. Patent Document 3 describes a conductive elastomer composition, containing conductive fibers obtained by coating the surface of inorganic fibers with silver while using silicone rubber for the matrix, as an example of a conductive elastomer.

Patent Document 4 describes conductive fibers, obtained by coating the surface of a fibrous substance with a mixture of a precious metal and one type or two or more types of an oxide thereof, as an example of conductive fibers in which the surface of inorganic fibers is coated with a metal.

In addition, Patent Document 5 describes a conductive composition having an adhesion layer of at least one type of metal selected from the group consisting of Pt, Au, Ru, Rh, Pd, Ni, Co, Cu, Cr, Sn and Ag on the surface of potassium titanate fibers.

In addition, Patent Document 6 describes a titanate having a prescribed reduced form of titanate crystals, and a metal coating, composed of at least one type of metal selected from the group consisting of Ni, Cu, Ag, Au and Pd, adhered to the surface thereof.

### PRIOR ART DOCUMENTS

### Patent Documents

Patent Document 1: JP 2011-208278 A

Patent Document 2: JP 2015-232180 A

Patent Document 3: JP H5-194856 A

Patent Document 4: JP S63-85171 A

Patent Document 5: JP S57-103204 A

Patent Document 6: JP S58-20722 A

### DISCLOSURE OF THE INVENTION

### Problems to be Solved by the Invention

When producing electrical components and electronic components, the conductive portions of the wiring and electrodes of electrical circuits and/or electronic circuits (to be collectively referred to as “wiring”) can be formed by printing a conductive paste into a prescribed shape followed by firing. Spherical metal particles or those processed into flake powder and the like are typically used for the conductive particles contained in the conductive paste.

In recent years, attempts have been made to form the wiring of electrical circuits and/or electronic circuits on the surface of materials capable of being bent and/or stretched. In the case of wiring formed on such materials, there is the risk of the wiring becoming disconnected due to bending and/or stretching of the material.

Therefore, an object of the present invention is to obtain a resin composition. capable of forming wiring of an electrical circuit and/or electronic circuit that has a low possibility of disconnection, and metal-coated particles capable of being used in that resin composition. More specifically, an object of the present invention is to obtain a resin composition capable of forming an electrical circuit and/or electronic circuit having a low possibility of disconnection on the surface of a material capable of bending and/or stretching, and metal-coated particles able to be used in that resin composition.

### Means for Solving the Problems

The present invention has the following configurations in order to solve the aforementioned problems.

(Configuration 1)

Configuration 1 of the present invention consists of metal-coated particles comprising a metal coating layer on a surface of titanium oxide, wherein the titanium oxide has a columnar shape having a particle length and a particle diameter and the particle length of the titanium oxide is longer than the particle diameter, and the metal-coated particles have a columnar shape having a particle length and a particle diameter and the particle length of the metal-coated particles is longer than the particle diameter.

Use of the metal-coated particles of Configuration 1 of the present invention allows the obtaining of a resin composition capable of forming the wiring of an electrical circuit and electronic circuit having a low possibility of disconnection. More specifically, use of the metal-coated particles of Configuration 1 of the present invention allows the obtaining of a resin composition capable of forming the wiring of an electrical circuit and/or electronic circuit having a low possibility of disconnection on the surface of a material capable of bending and/or stretching.

(Configuration 2)

Configuration 2 of the present invention consists of the metal-coated particles of Configuration 1, wherein the metal coating layer comprises at least one type of metal selected from the group consisting of Ag, Au, Cu, Ni, Pd, Pt, Sn and Pb.

According to Configuration 2 of the present invention, the metal coating layer containing a prescribed metal allows the formation of the wiring of an electrical circuit and/or electronic circuit having a low electric resistance.

(Configuration 3)

Configuration 3 of the present invention consists of the metal-coated particles of Configuration 1 or Configuration 2, wherein the particle length of the titanium oxide is 1 μm to 10 μm.

According to Configuration 3 of the present invention, the use of titanium oxide having a prescribed particle length makes it possible to reliably obtain metal-coated particles for obtaining a resin composition capable of forming the wiring of an electrical circuit and/or electronic circuit having a low possibility of disconnection. More specifically, according to Configuration 3 of the present invention, metal-coated particles can be reliably obtained for obtaining a resin composition capable of forming the wiring of an electrical circuit and/or electronic circuit having a low possibility of disconnection on the surface of a material capable of bending and/or stretching.

(Configuration 4)

Configuration 4 of the present invention consists of the metal-coated particles of any of Configurations 1 to 3, wherein the particle diameter of the titanium oxide is 0.05 μm to 1 μm.

According to Configuration 4 of the present invention, the use of titanium oxide having a prescribed particle diameter makes it possible to more reliably obtain metal-coated particles for obtaining a resin composition capable of forming the wiring of an electrical circuit and/or electronic circuit having a low possibility of disconnection. More specifically, according to Configuration 4 of the present invention, metal-coated particles can be more reliably obtained for obtaining a resin composition capable of forming the wiring of an electrical circuit and/or electronic circuit having a low possibility of disconnection on the surface of a material capable of bending and/or stretching.

(Configuration 5)

Configuration 5 of the present invention consists of the metal-coated particles of any of Configurations 1 to 4, wherein the particle length of the metal-coated particles is 1 μm to 10 μm and the particle diameter of the metal-coated particles is 0.05 μm to 1 μm.

According to Configuration 5 of the present invention, the use of metal-coated. particles having a prescribed particle length and prescribed particle diameter makes it possible to reliably obtain a resin composition capable of forming the wiring of an electrical circuit and/or electronic circuit having a low possibility of disconnection.

More specifically, according to Configuration 5 of the present invention, a resin composition can be reliably obtained that is capable of forming the wiring of an electrical circuit and/or electronic circuit having a low possibility of disconnection on the surface of a material capable of bending and/or stretching.

(Configuration 6)

Configuration 6 of the present invention consists of the metal-coated particles of any of Configurations 1 to 5, wherein the specific surface area of the titanium oxide is 2 m²/g to 20 m²/g.

According to Configuration 6 of the present invention, as a result of the titanium oxide having a prescribed specific surface area, metal-coated particles can be obtained of a suitable size for a resin composition for forming the wiring of an electrical circuit and/or electronic circuit.

(Configuration 7)

Configuration 7 of the present invention consists of the metal-coated particles of any of Configurations 1 to 6, wherein the weight ratio of the titanium oxide to the metal coating layer is within the range of 10:90 to 90:10.

According to Configuration 7 of the present invention, as a result of making the weight ratio of the titanium oxide to the metal coating layer in the metal-coated articles to be within the range of 10:90 to 90:10, metal-coated particles can be obtained that have suitable electrical conductivity.

(Configuration 8)

Configuration 8 of the present invention is a resin composition comprising the metal-coated particles of any of Configurations 1 to 7 and resin.

According to Configuration 8 of the present invention, use of the prescribed metal-coated particles allows the obtaining of a resin composition capable of forming the wiring of an electrical circuit and/or electronic circuit having a low possibility of disconnection. More specifically, according to Configuration 8 of the present invention, a resin composition can be obtained that is capable of forming the wiring of an electrical circuit and/or electronic circuit having a low possibility of disconnection on the surface of a material capable of bending and/or stretching.

### Effects of the Invention

According to the present invention, a resin composition capable of forming the wiring of an electrical circuit and/or electronic circuit having a low possibility of disconnection, and metal-coated particles able to be used in the resin composition, can be obtained. More specifically, according to the present invention, a resin composition capable of forming the wiring of an electrical circuit and/or electronic circuit having a low possibility of disconnection on the surface of a material capable of bending and/or stretching, and metal-coated particles able to be used in the resin composition, can be obtained.

### BRIEF DESCRIPTION OF THE DRAWINGS

FIG. 1 is scanning electron micrograph (magnification: 10,000×) of the metal-coated particles of the present invention.

FIG. 2 is a scanning electron micrograph (magnification: 5,000×) of the metal-coated particles of the present invention.

FIG. 3 is a scanning electron micrograph (magnification: 10,000×) of TiO₂ particles used in the production of the metal-coated particles of the present invention.

FIG. 4 is a scanning electron micrograph (magnification: 5,000×) of TiO₂ particles used in the production of the metal-coated particles of the present invention.

FIG. 5 is a schematic diagram for explaining particle length L and particle diameter D of the metal-coated particles of the present invention.

FIG. 6(a) is a schematic diagram for explaining the manner in which an electrode containing a plurality of the metal-coated particles of the present invention contacts adjacent metal-coated particles in the case of having been formed on a bendable and/or stretchable material.

FIG. 6(b) is a schematic diagram for explaining that an electrode containing a plurality of the metal-coated particles of the present invention is able to maintain contact with adjacent metal-coated particles even in the case of having been formed on a bendable and/or stretchable material and in the case of the material having been bent and/or stretched.

FIG. 7(a) is a schematic diagram for explaining the manner in which an electrode containing a plurality of conventional spherical conductive particles contacts adjacent conductive particles in the case of having been formed on a bendable and/or stretchable material.

FIG. 7(b) is a schematic diagram for explaining that an electrode containing a plurality of conventional spherical conductive particles is unable to maintain contact with adjacent conductive particles in the case of having been formed on a bendable and/or stretchable material and in the case of the material having been bent and/or stretched.

### MODE FOR CARRYING OUT THE INVENTION

The present invention relates to metal-coated particles having a metal coating layer on the surface of titanium oxide. The titanium oxide of the metal-coated particles of the present invention has a columnar shape having a prescribed particle length and particle diameter. The particle length of the titanium oxide of the metal-coated particles of the present invention is longer than the particle diameter thereof. The metal-coated particles of the present invention are metal-coated particles obtained by applying a metal coating to titanium oxide of a prescribed shape. The metal-coated particles of the present invention have a columnar shape having a particle length and particle diameter, and the particle length of the metal-coated particles is longer than the particle diameter.

In the present description, “particle length” refers to the longest distance (maximum dimension) between any two points on the surface of the particles. Furthermore, in the case of having captured an electron micrograph (SEM micrograph) of a powder containing a large number of the metal-coated particles, particle length can be approximated with the longest distance (maximum dimension) between any two points on the contour of each particle in the SEM micrograph. Thus, the value of the particle length of metal-coated particles can be obtained by capturing an electron micrograph (SEM micrograph) of powder containing a large number of metal-coated particles, measuring the maximum dimension of the contour of each particle captured in the SEM micrograph, and calculating the average value thereof. In addition, the maximum dimension of the contour of each particle can be measured by processing images of the contour of each particle captured in an SEM micrograph using known image processing technology.

In the present description, “particle diameter” refers to the longest distance (maximum dimension) between any two points on the contour of a cross-section having the largest cross-sectional area among particle cross-sections perpendicular to a line connecting two points indicating particle length. Furthermore, in the case of having captured an electron micrograph (SEM micrograph) of powder containing a large number of metal-coated particles, particle diameter can be approximated from maximum length among the lengths of line segments of the inside portion of the contour of each particles of any straight line perpendicular to a line connecting two points indicating particle length. Thus, the value of particle diameter of a metal-coated particle can be obtained by capturing an electron micrograph (SEM micrograph) of a powder containing a large number of metal-coated particles, measuring the maximum length among the lengths of line segments of the inside portion of the contour of each particles of any straight line perpendicular to a line connecting two points indicating particle length, and calculating the average value thereof. In addition, particle diameter can be measured from the contour of each particle by processing images of the contour of each particle captured in an SEM micrograph using known image processing technology.

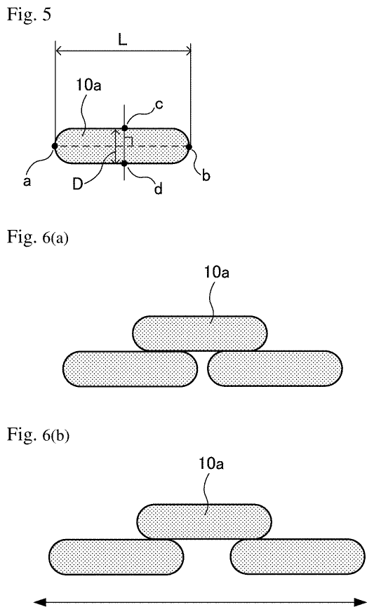

The following provides an explanation of the case of measuring particle length L and particle diameter D of using a metal-coated particle 10a obtained from an SEM micrograph using the schematic diagram of FIG. 5. Particle length L is the longest distance (distance L between point a and point b) among the distances between any two points on the contour of the metal-coated particle 10a in the SEM micrograph. In addition, diameter D is the maximum length (length D of a line segment connecting point c and point d) among the lengths of line segments of the inside portion of the contour of each particle of any line (such as a line passing through point c and point d) perpendicular to the line connecting two points indicating particle length L (point a and point b). The value of particle diameter of a metal-coated particle can be obtained by measuring particle length L and particle diameter D of each particle in an SEM micrograph and calculating the average value thereof. Furthermore, the magnification factor of the SEM micrograph can be suitably selected so that the entire image of the prescribed measured number of metal-coated particles is present in the resulting image.

In addition, the prescribed measured number for calculating the average value is preferably 5 or more, within the range of 10 to 100, and preferably 20 to 50.

In the present description, “columnar shape” refers to a shape in which particle length is longer than particle diameter.

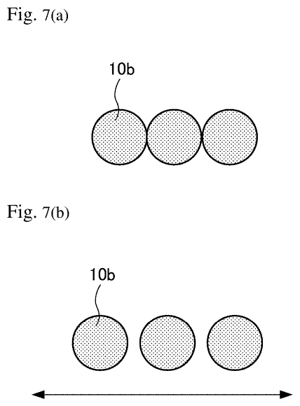

In general, conductive particles 10b contained in a resin composition in the manner of a conductive paste have a spherical or flake-like shape (see FIG. 7(a)). In the case of forming the wiring of an electrical circuit and/or electronic circuit on the surface of material capable of bending and/or stretching using the conductive particles Ob having such a shape, contact between adjacent conductive particles 10b may be interrupted due to bending and/or stretching of the material (see FIG. 7(b)). In this case, this interruption of electrical contact causes a disconnection. On the other hand, as shown in FIG. 6(a), in the case of using the conductive particles 10a having a prescribed columnar shape (metal-coated particles of the present invention), adjacent conductive particles 10a. are able to make contact while the lateral portions of the long, narrow columnar shape thereof shift. Consequently, as shown in FIG. 6(b), contact between adjacent conductive particles 10a is able to be maintained even if the material undergoes a certain degree of bending and/or stretching. Consequently, the possibility of a disconnection becomes low in the case of using the columnar-shaped conductive particles 10a.

Normally, in the case of using a conductive paste containing conductive particles of the prior art, since the shape of the conductive particles is spherical or flake-like, there is a high possibility of disconnection when forming the wiring of an electrical circuit and/or electronic circuit on the surface of a material capable of bending and/or stretching. On the other hand, it is not easy to produce conductive particles having a columnar shape.

The inventors of the present invention found that conductive particles having a columnar shape can be obtained by preparing a particle-shaped insulating substance, and more specifically, titanium oxide particles, and coating the surface thereof. Since titanium oxide particles of a prescribed shape can be produced comparatively easily, conductive particles having a prescribed columnar shape can also be produced comparatively easily. Thus, titanium oxide (TiO₂) particles are optimal for use as the raw material (insulating substance) of conductive particles having a columnar shape. Furthermore, particles consisting of metal alone have higher conductivity in comparison with the metal-coated particles of the present invention. However, metal particles such as silver particles exhibiting high conductivity are typically more expensive than the metal-coated particles of the present invention. In addition, minute metal particles having a prescribed columnar shape are not easy to produce. Thus, the metal-coated particles of the present invention are optimal for forming wiring and the like having a desired conductivity at low cost. In addition, since titanium oxide is highly stable, the use of the metal-coated particles of the present invention allows the obtaining of wiring and the like having a long service life.

In addition, in the case of using an alkaline salt such as potassium titanate for the insulating substance, there is the possibility of alkaline salt impurities having a detrimental effect on electronic components. In order to avoid this detrimental effect, the use of titanium oxide for the insulating substance enables the formation of an electrode without having a detrimental effect on electronic components. Furthermore, the obtaining of particles having a prescribed columnar shape is comparatively easy in the case of titanium oxide.

The use of the metal-coated particles of the present invention having titanium oxide of a prescribed shape at the core thereof allows the obtaining of a resin composition capable of forming the wiring of an electrical circuit and/or electronic circuit having a low possibility of disconnection. More specifically, use of the metal-coated particles allows the obtaining of a resin composition capable for forming the wiring of an electrical circuit and/or electronic circuit having a low possibility of disconnection on the surface of a material capable of bending and/or stretching. Thus, use of a resin composition containing the metal-coated particles of the present invention is thought to result in a low possibility of circuit disconnection even in the case of having formed the wiring of an. electrical circuit and/or electronic circuit on a material capable of bending and/or stretching.

In the metal-coated particles of the present invention, the particle length of the titanium oxide is preferably 1 μm to 10 μm, more preferably 1.5 μm to 6.0 μm and even more preferably 1.5 μm to 5.2 μm. As a result of making the particle length of the titanium oxide to be within these ranges, the wiring of an electrical circuit and/or electronic circuit can be formed that has a low possibility of disconnection.

In the metal-coated particles of the present invention, the particle diameter of the titanium oxide is preferably 0.05 μm to 1 μum and more preferably 0.1 μm to 0.3 μm. As a result of making the particle diameter of the titanium oxide to be within these ranges, the wiring of an electrical circuit and/or electronic circuit can be formed that has a low possibility of disconnection. In addition, the use of titanium oxide that combines the aforementioned ranges of particle length and ranges of particle diameter allows the obtaining of metal-coated particles for obtaining a conductive composition capable of forming the wiring of an electrical circuit and/or electronic. circuit having a low possibility of disconnection.

In the metal-coated particles of the present invention, the specific surface area of the titanium oxide is preferably 2 m²/g to 20 m²/g, more preferably 3 m²/g to 15 m²/g, even more preferably 5 m²/g to 10 m²/g and particularly preferably 5 m²/g to 7 m²/g. As a result of the titanium oxide having a prescribed specific surface area, metal-coated particles can be obtained having suitable dimensions for a resin composition for forming the wiring of an electrical circuit and/or electronic circuit. Furthermore, the dimensions of the metal-coated particles are larger than titanium oxide by the amount of the metal coating layer.

In the metal-coated particles of the present invention, the metal coating layer preferably contains at least one type of metal selected from the group consisting of Ag, Au, Cu, Ni, Pd, Pt, Sat and Pb. As a result of the metal coating layer containing a prescribed metal, the wiring of an electrical circuit and/or electronic circuit can be formed that has a low electric resistance. The electrical conductivity of silver (Ag) is particularly high. Consequently, the metal coating layer is preferably formed using Ag.

in the metal-coated particles of the present invention, the particle length of the metal-coated particles is preferably 1 μm to 10 μm, more preferably 1.5 μm to 6.0 μm and even more preferably 1.5 μm to 5.2 μm. In the metal-coated particles of the present invention, the particle diameter of the metal-coated particles is preferably 0.05 μm to 1 μm and more preferably 0.1 μm to 0.3 μm. The use of metal-coated particles combining these ranges of particle length and ranges of particle diameter allows the obtaining of a conductive composition capable of forming the wiring of an electrical circuit and/or electronic circuit having a low possibility of disconnection. In addition, in the case of forming wiring by screen-printing a resin composition containing metal-coated particles, the wiring can be formed by screen printing without problem by using metal-coated particles having a prescribed particle length and prescribed particle diameter.

In the metal-coated particles of the present invention, the weight ratio of titanium oxide to the metal coating layer (titanium oxide metal coating layer) is preferably within the range of 10:90 to 90:10, more preferably within the range of 10:90 to 70:30 and even more preferably within the range of 10:90 to 50:50. The weight ratio of titanium oxide to the metal coating layer can be controlled by controlling the particle dimensions of the titanium oxide and thickness of the metal coating layer. The weight ratio of the titanium oxide to the metal coating layer can be suitably selected according to the application. The weight ratio of the metal coating layer is preferably large from the viewpoint of obtaining high electrical conductivity, However, if the weight ratio of the titanium oxide serving as the core is less than 10% by weight, it becomes difficult to form the metal-coated particles and obtain the prescribed columnar shape. By making the weight ratio of the titanium oxide to the metal coating layer to be within a prescribed range, metal-coated particles having suitable electrical conductivity can be obtained.

The surface of the metal-coated particles of the present invention is preferably treated with a surface treatment agent. Fatty acids and fatty acid salts can be preferably used for the surface treatment agent. Treating the surface of the metal-coated particles with a surface treatment agent increases wettability with the resin component and allows the obtaining of high dispersibility.

The following provides an explanation of a method for producing the metal-coated particles of the present invention.

First, titanium oxide (TiO₂) having the aforementioned prescribed columnar shape is prepared. The titanium oxide (TiO₂) having a prescribed columnar shape able to be used in the metal-coated particles of the present invention is known and can be acquired commercially. Acicular titanium oxide manufactured by Ishihara Sangyo Kaisha Ltd. (member of the FTL Series such as FTL-300), for example, can be used for the titanium oxide having a prescribed columnar shape. Rutile type crystals can be used for the crystal structure of the titanium oxide.

Next, metal is coated onto the titanium oxide having a prescribed columnar shape. Coating of metal onto the titanium oxide can be carried out by a known deposition method such as plating, vacuum deposition and chemical vapor deposition (CVD). Plating (electro-less plating) is used preferably since deposition can be carried out at a comparatively low cost without using vacuum equipment. The following provides an explanation of the case of coating the titanium oxide having a prescribed columnar shape with silver by plating as one example of a coating method.

First, the titanium oxide having a prescribed columnar shape is subjected to sensitizing treatment. More specifically, sensitizing treatment includes immersing titanium oxide particles in sensitizing solution to cause a metal compound such as an Sn compound to be adsorbed onto the titanium oxide particles. A solvent containing a Sn compound can he used for the sensitizing solution. Examples of Sn compounds that can be used are selected from stannous chloride (SnCl₂), stannous acetate (Sn(CH₃COCHCOCH₃)₂), stannous bromide (SnBr₂), stannous iodide (SnI₂) and stannous sulfate (SnSO₄). Examples of solvents that can be used are selected from alcohols, aqueous alcohol solutions and dilute solutions of hydrochloric acid.

Following sensitizing treatment, the titanium oxide particles are preferably filtered, dehydrated and washed.

Next, activating treatment is carried out on the sensitized titanium oxide. More specifically, activating treatment includes immersing the sensitized titanium oxide particles in activating solution to adsorb a plating catalyst onto the titanium oxide particles. Pd, Ag or Cu can be preferably used for the plating catalyst. In the case of coating silver by plating, Ag is preferably used for the plating catalyst. in the case of using Ag for the plating catalyst, an aqueous solution containing silver nitrate and aqueous ammonia can be used for the activating solution.

Following activating treatment, the titanium oxide particles are preferably filtered, dehydrated, washed and dried. Drying can be carried out for about 1 hour to 20 hours at a temperature of, for example, 30° C. to 100° C. Adhesion between the titanium oxide particles and metal coating layer can he enhanced by filtering, dehydrating, washing and drying the titanium oxide particles.

Furthermore, sensitizing and activating treatment can be repeatedly carried out a plurality of times such as from about two to five times. Uneven adsorption of the plating catalyst can be decreased by repeatedly carrying out sensitizing and activating treatment a plurality of times.

Next, plating treatment is carried out on the titanium oxide following completion of sensitizing treatment and activating treatment. More specifically, plating treatment includes immersing the sensitized and activated titanium oxide particles in a plating solution. As a result, a silver metal coating layer can be formed. on the surface of the titanium oxide particles by electro-less plating. An aqueous solution containing, for example, silver nitrate and aqueous ammonia can be used for the plating solution.

The above has provided an explanation using the case of forming a silver metal coating layer as an example. Metal coating layers of other metals can be formed by changing the plating solution used in plating treatment. Methods are known for forming a metal coating layer of a metal other than Ag such as Au, Cu, Ni, Pd, Pt, Sn and Pb by electro-less plating. In addition, electro-less plating of Co, Rh or In and the like can also be carried out. Thus, metal-coated particles having a metal coating layer using these metals as raw materials can be produced using an electro-less plating method.

The metal-coated particles of the present invention can he produced in the manner of the aforementioned example.

Next, an explanation is provided of the resin composition of the present invention. The present invention is a resin composition containing the aforementioned metal-coated particles and resin.

The resin composition of the present invention contains the aforementioned metal-coated particles of the present invention as conductive particles. Furthermore, the resin composition of the present invention can contain conductive particles other than the columnar-shaped metal-coated particles of the present invention as conductive particles. Spherical and/or flake-like conductive particles can be contained as conductive particles other than the metal-coated particles of the present invention. Furthermore, the conductive particles contained in the resin composition of the present invention are such that the weight ratio of the metal-coated particles of the present invention to conductive particles other than the metal-coated particles of the present invention (metal-coated particles: other conductive particles) is preferably 98:2 to 70:30 and more preferably 95:5 to 90:10. Materials similar to the metal material used in the metal coating layer of the metal-coated particles of the present invention can be used for the material of the conductive particles other than the metal-coated particles of the present invention.

The resin contained in the resin composition can be used by selecting from thermoplastic resins, thermosetting resins and/or photocuring resins. Examples of thermoplastic resins include acrylic resin, ethyl cellulose, polyester, polysulfone, phenoxy resin, polyimide resin and the like. Preferable examples of thermosetting resins include amino resins in the manner of urea resin, melamine resin or guanamine resin, epoxy resins such as bisphenol A type, bisphenol F type, phenol novolac type or alicyclic resin, oxetane resin, phenol resins in the manner of resol-type or novolac-type resin, silicone-modified organic resins in the manner of silicone epoxy or silicone polyester resin and the like. UV-curable acrylic resin or UV-curable epoxy resin and the like can be used as photocuring resins. These resins may be used alone or two or more types may be used in combination.

In the resin composition of the present invention, the weight ratio of metal-coated particles to resin is preferably 90:10 to 70:30. If the weight ratio of metal-coated particles to resin is within the aforementioned ranges, a coating film or wiring can be formed by applying the resin composition containing the metal-coated particles to a substrate, and the metal film or wiring obtained by heating this coating film or wiring is able to maintain a desired value of specific resistance. Furthermore, in the case the resin composition contains conductive particles other than the metal-coated particles of the present invention, the weight ratio of all conductive particles is preferably within the aforementioned ranges.

The resin composition of the present invention can further contain a solvent.

Examples of the solvent include aromatic hydrocarbons in the manner of toluene or xylene, ketones in the manner of methyl ethyl ketone, methyl isobutyl ketone or cyclohexanone, esters in the manner of ethylene glycol monomethyl ether, ethylene glycol monoethyl ether, ethylene glycol monobutyl ether, diethylene glycol monomethyl ether, diethylene glycol monoethyl ether, diethylene glycol monobutyl ether and their corresponding acetates, terpineol and the like. The solvent is preferably incorporated at 2 parts by weight to 10 parts by weight based on a total of 100 parts by weight of the metal-coated particles and resin.

The resin composition of the present invention can further contain at least one type of additive selected from the group consisting of inorganic pigment, organic pigment, silane coupling agent, leveling agent, thixotropic agent and antifoaming agent.

The resin composition of the present invention can be produced by adding the aforementioned metal-coated particles of the present invention, resin and other components depending on the case to a mixer such as a planetary stirrer, dissolver, bead mill, crusher, three-roll mill, rotary mixer or biaxial mixer followed by mixing. In this manner, a resin composition can be produced that has viscosity suitable for screen printing, immersion or other desired coating film or wiring formation methods.

Use of the resin composition of the present invention allows the formation of the wiring of an electrical circuit and/or electronic circuit having a low possibility of disconnection. More specifically, use of the resin composition of the present invention allows the formation of the wiring of an electrical circuit and/or electronic circuit having a low possibility of disconnection on the surface of a material capable of bending and/or stretching.

### EXAMPLES

### Example 1

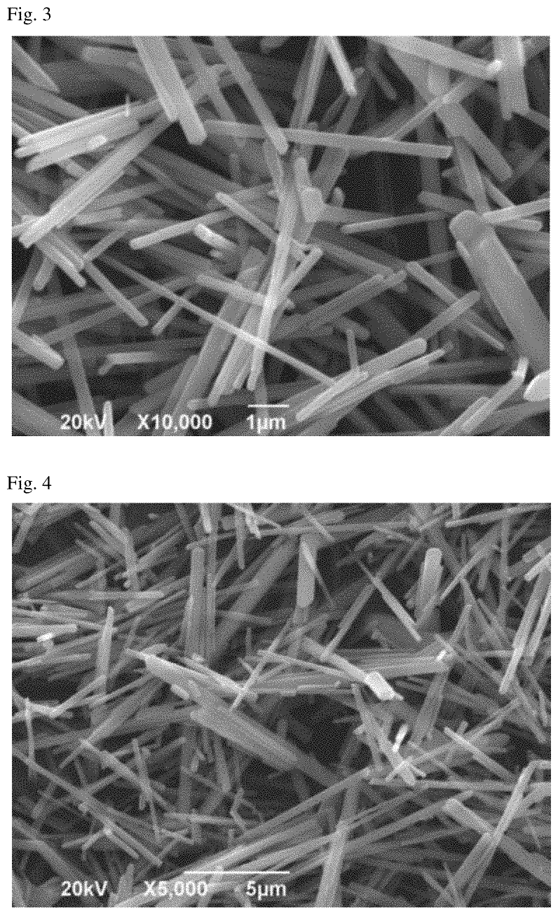

Acicular titanium oxide manufactured by Ishihara Sangyo Kaisha Ltd. (FTL-300) was used for the titanium oxide (TiO₂) powder serving as raw material in Example 1. Furthermore, FTL-300 is a rutile-type TiO₂ powder having a particle length of 5.15 μm and particle diameter of 0.27 μm, the true specific gravity is 4.2 and the specific surface area is 5 to 7. FIGS. 3 and 4 show scanning electron micrographs of the titanium oxide powder serving as raw material.

The titanium oxide was coated with metal in the manner described below. First, sensitizing treatment was carried out on the titanium oxide powder. More specifically, 50 g of titanium oxide powder were dispersed in 800 g of ion exchange water, and a sensitizing solution of ion exchange water (20 g) containing 2.5 g of stannous chloride and 0.5 g of hydrochloric acid was prepared. Sensitizing treatment was carried out for 10 minutes using this sensitizing solution. Subsequently, the titanium oxide powder was filtered followed by dehydration and washing.

Next, activating treatment was carried out on the titanium oxide powder subjected to sensitizing treatment. More specifically, the aforementioned sensitized titanium oxide powder was dispersed in 900 g of ion exchange water, and an activating solution of ion exchange water (100 g) containing 5 g of silver nitrate and 10 ml of aqueous ammonia (concentration: 25%) was prepared. Activating treatment was carried out for 10 minutes using this activating solution. Subsequently, the titanium oxide powder was filtered followed by dehydration and washing. The resulting titanium oxide powder was dried for 12 hours at 60° C.

A silver metal coating layer was formed on the surface of the titanium powder subjected to sensitizing and activating treatment by plating treatment (electro-less plating). More specifically, 20 g of the titanium oxide powder treated in the manner described above were dispersed in 690 g of ion exchange water followed by the addition of ion exchange water (50 g) containing 32 g of silver nitrate and 50 ml of aqueous ammonia (concentration: 25%). Subsequently, 10 ml of sulfuric acid were further added followed by the further addition of 200 ml of aqueous ammonia.

(concentration: 25%). 11 g of an aqueous solution (50 g ion exchange water) of hydrazine monohydrate were added over the course of 7 minutes to the solution (plating solution) obtained in the manner described above to form a metal coating layer of silver on the surface of the titanium oxide particles and obtain metal-coated particles. Furthermore, the aqueous solution of hydrazine monohydrate was added while stirring.

Following completion of the aqueous solution of hydrazine monohydrate, stirring was continued for 15 minutes or more. Subsequently, the metal-coated particles were filtered out, dehydrated and washed. The resulting metal-coated particles were dried for 12 hours at 60° C.

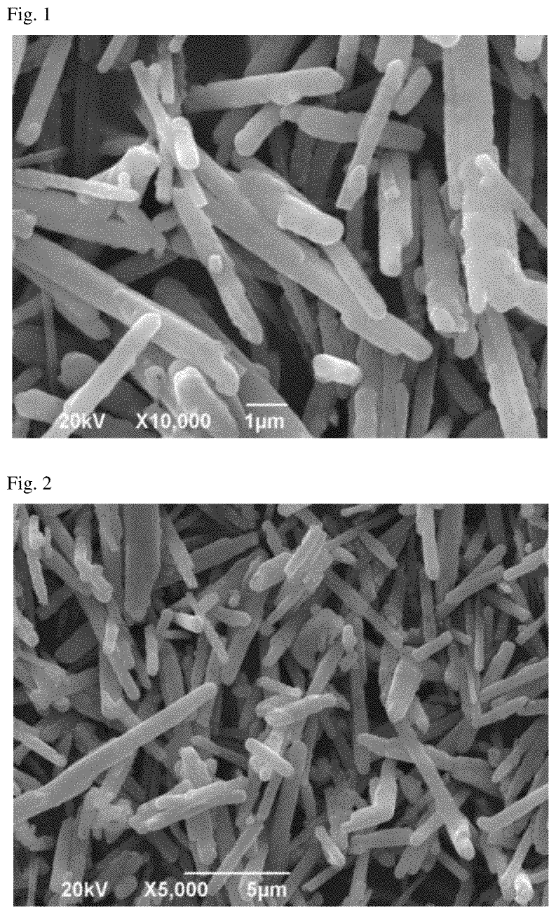

FIGS. 1 and 2 show scanning electron micrographs of the metal-coated particles obtained in the manner described above. The weight ratio of titanium oxide to the metal coating layer of the metal-coated particles obtained in the manner described above was 50:50. Furthermore, measurement of the BET specific surface area of the titanium oxide powder and metal-coated particles revealed that the BET specific surface area of the titanium oxide powder was 2.80 m²/g and the BET specific surface area of the metal-coated particles was 1.83 m²/g. Measurement of the average values of particle length and particle diameter of the metal-coated particles revealed that the particle length was 5.25 μm and the particle diameter was 0.37 μm. On the basis of the above, metal-coated particles having a prescribed columnar shape were clearly determined to be able to be obtained according the aforementioned method.

The metal-coated particles shown in FIGS. 1 and 2 have long, narrow columnar shape. In the case of having formed wiring and/or electrodes on the surface of a stretchable material using these metal-coated particles, the lateral surfaces of the metal-coated particles contact each other, enabling contact between metal-coated particles to be maintained even in the case the material has stretched and reducing disconnections. In addition, since the long, narrow columnar shape of these metal-coated particles causes the metal-coated particles to become entangled, disconnections can be reduced even in the case of having formed wiring and/or electrodes on the surface of a bendable material using these metal-coated particles.

The resin composition of the present invention can be produced by mixing metal-coated particles obtained in the manner described above and a prescribed resin with a three-roll mill and the like. Use of the resin composition of the present invention allows the formation of the wiring of an electrical circuit and/or electronic circuit having a low possibility of disconnection on the surface of a material capable of bending and/or stretching.

### DESCRIPTION OF THE NUMERAL REFERENCES

10a Conductive particles (metal-coated particles)
10b conductive particles
L Particle length of metal-coated particles
D Particle diameter of metal-coated particles

1. Metal-coated particles comprising a metal coating layer on a surface of titanium oxide, wherein:
the titanium oxide has a columnar shape having a particle length and a particle diameter, the particle length of the titanium oxide being longer than the particle diameter, and
the metal-coated particles have a columnar shape having a particle length and a particle diameter, the particle length of the metal-coated particles being longer than the particle diameter.

2. The metal-coated particles according to claim 1, wherein the metal coating layer comprises at least one type of metal selected from the group consisting of Ag, Au, Cu, Ni, Pd, Pt, Sn and Pb.

3. The metal-coated particles according to claim 1, wherein the particle length of the titanium oxide is 1 μm to 10 μm.

4. The metal-coated particles according to claim 1, wherein the particle diameter of the titanium oxide is 0.05 μm to 1 μm.

5. The metal-coated particles according to claim 1, wherein the particle length of the metal-coated particles is 1 μm to 10 μm and the particle diameter of the metal-coated particles is 0.05 μm to 1 μm.

6. The metal-coated particles according to claim 1, wherein the specific surface area of the titanium oxide is 2 m²/g to 20 m²/g.

7. The metal-coated particles according to claim 1, wherein the weight ratio of the titanium oxide to the metal coating layer is within the range of 10:90 to 90:10.

8. A resin composition comprising the metal-coated particles according to claim 1, and resin.

9. The metal-coated particles according to claim 2, wherein the particle length of the titanium oxide is 1 μm to 10 μm.

10. The metal-coated particles according to claim 2, wherein the particle diameter of the titanium oxide is 0.05 μm to 1 μm.

11. The metal-coated particles according to claim 3, wherein the particle diameter of the titanium oxide is 0.05 μm to 1 μm.

12. The metal-coated particles according to claim 2, wherein the particle length of the metal-coated particles is 1 μm to 10 μm and the particle diameter of the metal-coated particles is 0.05 μm to 1 μm.

13. The metal-coated particles according to claim 3, wherein the particle length of the metal-coated particles is 1 μm to 10 μm and the particle diameter of the metal-coated particles is 0.05 μm to 1 μm.

14. The metal-coated particles according to claim 4, wherein the particle length of the metal-coated particles is 1 μm to 10 μm and the particle diameter of the metal-coated particles is 0.05 μm to 1 μm.

15. The metal-coated particles according to claim 2, wherein the specific surface area of the titanium oxide is 2 m²/g to 20 m²/g.

16. The metal-coated particles according to claim 3, wherein the specific surface area of the titanium oxide is 2 m²/g to 20 m²/g.

17. The metal-coated particles according to claim 4, wherein the specific surface area of the titanium oxide is 2 m²/g to 20 m²/g.

18. The metal-coated particles according to claim 5, wherein the specific surface area of the titanium oxide is 2 m²/g to 20 m²/g.

19. The metal-coated particles according to claim 2, wherein the weight ratio of the titanium oxide to the metal coating layer is within the range of 10:90 to 90:10.

20. The metal-coated particles according to claim 3, wherein the weight ratio of the titanium oxide to the metal coating layer is within the range of 10:90 to 90:10.
